(19) United States
(12) Patent Application Publication
(10) Pub. No.: US 2016/0283480 A1
(43) Pub. Date: Sep. 29, 2016

(54) ASSIGNING CONTENT OBJECTS TO DELIVERY NETWORKS

(71) Applicant: LinkedIn Corporation, Mountain View, CA (US)

(72) Inventors: Zhenyun Zhuang, Belmont, CA (US); Ritesh Maheshwari, Mountain View, CA (US); Haricharan K. Ramachandra, Fremont, CA (US); Badrinath K. Sridharan, Saratoga, CA (US)

(73) Assignee: LINKEDIN CORPORATION, Mountain View, CA (US)

(21) Appl. No.: 14/669,910

(22) Filed: Mar. 26, 2015

(51) Int. Cl. G06F 17/30; H04L 29/06; H04L 12/26; G06F 17/22

(52) U.S. Cl. CPC G06F 17/3053; G06F 17/2247; H04L 67/42; H04L 43/16

(57) ABSTRACT

A system, method, and apparatus are provided for assigning or allocating multiple content objects, within a content page (e.g., web page) or other content collection (e.g., a set of pages), to different content delivery networks for delivery in response to a content request. The objects are ranked by importance (e.g., importance in rendering or presenting the page), and the networks are ranked by performance (e.g., throughput). In order of importance, the objects are assigned to the best-performing network that is “available.” Some or all networks are initially available, and a given network becomes “unavailable” after it has been assigned its portion of the objects (e.g., based on content, number of objects, amount of data, percentage). If a total accumulated cost of delivering the objects exceeds a target before all objects have been allocated, the allocation process may terminate early and the remaining objects may be assigned to the least-expensive network.

### BACKGROUND

This disclosure relates to the field of computers. More particularly, a system, method, and apparatus are provided for selecting networks for delivering individual content pages (or other content collections) and/or components of an individual page or collection of electronic content.

Some content providers concurrently use multiple different content delivery networks (CDNs) to deliver content to users. However, they may apply simplistic strategies for delivering a given content page to a given user, such as by randomly sending different content pages or objects via the various networks.

However, random selection of CDNs provides neither the best performance (e.g., as measured by delivery time) nor the least cost, because different networks provide different levels of performance and involve different costs. Using solely (or primarily) the best-performing CDN in order to provide good experiences will likely incur high costs, whereas attempting to minimize costs by solely (or primarily) using the least expensive CDN will likely result in substandard performance.

### DESCRIPTION OF THE FIGURES

FIG. 1 is a block diagram depicting a computing environment in which content is allocated among multiple networks for delivery to requesting users, in accordance with some embodiments.

FIG. 2 is a flow chart illustrating a method of allocating content among multiple networks for delivery to requesting users, in accordance with some embodiments.

FIG. 3 depicts an apparatus for allocating content among multiple networks for delivery to requesting users, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, method, and apparatus are provided for allocating or assigning content to different content delivery networks (CDNs) for delivery in response to requests for the content. Entire pages of content (e.g., web pages) may be allocated in these embodiments, or individual objects or components of a page or other collection of content.

For example, a web page or other page of content to be delivered to a user may include multiple individual objects. For each of a number of the page's objects, the object is allocated or assigned to a particular network, but generally not all objects will be allocated to the same network.

To determine the order in which to allocate objects (e.g., of a page) or items (e.g., entire pages), some or all of them are ranked based on a measure of their importance, and the objects or items are subsequently assigned to CDNs in order of their importance (from most important to least important). Their importance rank may depend upon how critical they are to construction of the page or content collection of which they are part, how much they would or might affect the user's enjoyment of or experience with the page, how likely they are to generate income for the content provider, how likely it is that the user will interact with them, how much data they contain (i.e., their size), how or where they will be displayed within a display screen of a device operated by the user, how important they may be to the user, and/or other factors.

Similarly, the CDNs are ranked based on their throughput (e.g., how fast a given object or set of data can be delivered) or some other measure of performance, cost, proximity (e.g., to the user, to the content provider), and/or other factors. Therefore, in embodiments discussed below, the most important content objects can be dispatched via the best delivery networks, therefore promoting performance and/or improving users' experiences.

As each object is assigned to a content delivery network, the cost of delivering the object to the user via the assigned network is determined or estimated (e.g., based on a cost assessed by the network). Each time an object is assigned to a CDN, the total accumulated cost of delivering the entire set or page of objects is updated and, for the assigned CDN, the total cost of delivering the objects assigned to the CDN is updated.

A target total cost for the page or collection of content is set, which may be calculated or determined from historical records of serving the same page and/or other pages (e.g., all pages, a set of similar pages). For example, the average (or median) cost of serving that page some number of times, or during some historical period, may be calculated and used as the target total cost.

Similarly, a target cost for each CDN that will or may be used to deliver the content objects or collection may be set. This target CDN cost for a given CDN may be an average of past costs of delivering objects from the page, a median, or some other measure, or may be a percentage of the target total cost that is allocated to the given CDN.

For example, in some implementations, each of the multiple CDNs is granted a target percentage of total costs of delivering content (e.g., as a percentage of content objects of a particular page, of some or all content objects, of some or all content pages) on behalf of a content provider. Those target CDN percentages may then be used to apportion or allocate the target total cost for a page or set of objects among the participating content delivery networks.

Initially, when a given page or set of content objects/components is identified for delivery to a user, all of the multiple CDNs are considered “available.” During allocation or assignment of the content objects to the CDNs, a given object can only be assigned to a CDN that is still “available” at the time of assignment. A given CDN becomes “unavailable” when the total cost calculated or estimated for the page's objects assigned to the CDN exceed a threshold or maximum cost set for the CDN.

During allocation of content to CDNs, the allocation will naturally terminate when all objects have been allocated. The process may terminate early if and when the current total accumulated cost matches or exceeds the target total cost, or may terminate early if all of the multiple CDNs become unavailable before all objects have been allocated. In this event, remaining objects may be immediately assigned to the least expensive CDN, may be randomly assigned to the CDNs that are available, or some other action may be taken to have them delivered.

Content delivered by the system may be measured in terms of objects and/or data sizes, and costs may be assessed and accumulated in the same manner. Thus, references herein to a cost of serving content may refer to a cost per object and/or a cost per unit of data (e.g., KB, MB, GB).

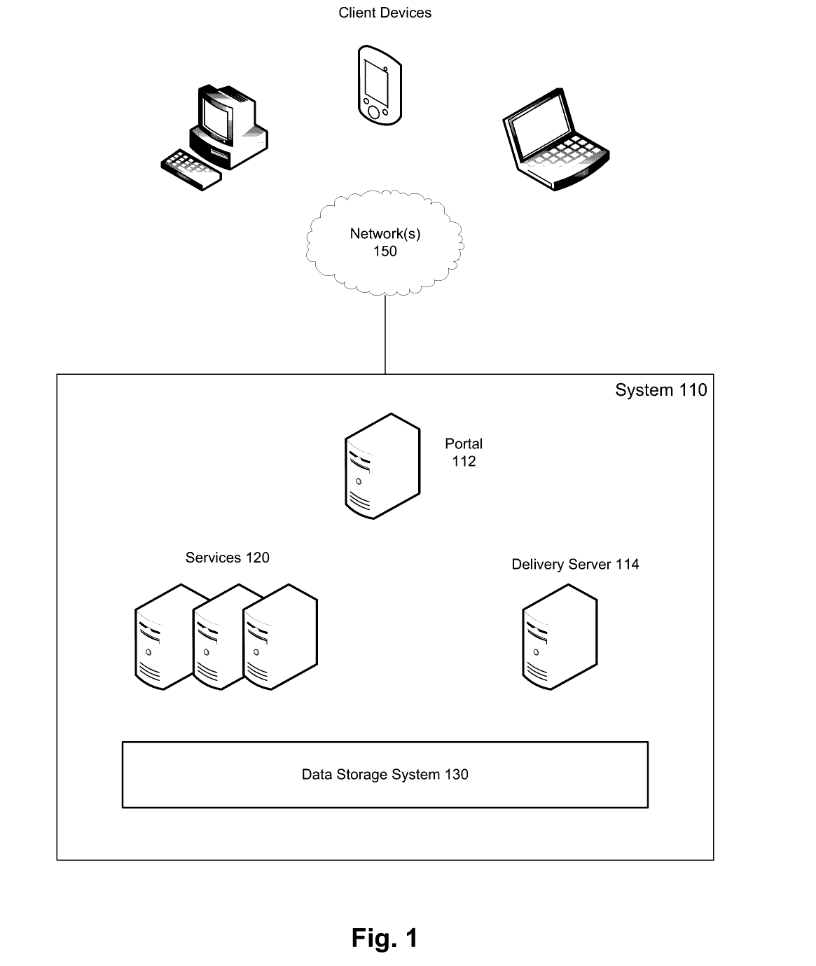

FIG. 1 is a block diagram depicting a computing environment in which content is assigned to different content delivery networks, based on importance, according to some embodiments.

System 110 of FIG. 1 is (or is part of) a data center that supports or hosts an online application or service. The application or service may feature a community or network of users, such as a professional network offered by LinkedIn® Corporation or a social network. Users of system 110 may be termed members because they may be required to register with the system in order to use the application or service. Members may be identified and differentiated by username, electronic mail address, telephone number, and/or some other unique identifier.

Users/members of a service or services hosted by system 110 connect to the system via client devices, which may be stationary (e.g., desktop computer, workstation) or mobile (e.g., smart phone, tablet computer, laptop computer). In order to interact with the system (e.g., to view content, submit or edit content) the client devices operate suitable client applications, such as a browser program or an application designed specifically to access a service offered by system 110.

Client devices are coupled to system 110 via direct channels and/or one or more networks 150 or other shared channels, which may include the Internet, intranets, and/or other networks, and may incorporate wired and/or wireless communication links. Multiple content delivery networks (CDNs) deliver content to users of the client devices, on behalf of system 110 and/or other applications and services.

Interactive user/member sessions with system 110 are generally made through portal 112, which may comprise a web server, an application server, and/or some other gateway or entry point. The portal through which a given session is established may depend on the member's device or method of connection. For example, a user of a mobile client device may connect to system 110 via a different portal (or set of portals) than a user of a desktop or workstation computer. Thus, portal 112 is the initial recipient of content requests from devices operated by members (e.g., HTML GET requests).

System 110 includes delivery server 114, data storage system 130, and various services, represented by services 120 in FIG. 1, which may be hosted by any number of discrete servers. Delivery server 114 supports the allocation of content (e.g., content requested by a member) among content delivery networks for delivery to users of the client devices, as further described below. Data storage system 130, which may be a distributed data storage system, and/or components of the data storage system (e.g., separate storage engines) include appropriate data storage devices (e.g., disks, solid-state drives), and stores data used by portal 112, delivery server 114, services 120, and/or other components of system 110 not depicted in FIG. 1.

Among services 120 may be one or more individual system servers configured to serve content, track activity within system 110, record member profiles, and so on.

For example, a profile service or server may maintain profiles of members of the service(s) hosted by system 110, which may be stored in data storage system 130 and/or elsewhere. An individual member's profile may include or reflect any number of attributes or characteristics of the member, including personal (e.g., gender, age or age range, interests, hobbies, member ID), professional (e.g., employment status, job title, employer or associated organization, industry, functional area or role, skills, endorsements, professional awards), social (e.g., organizations the user is a member of, geographic area of residence, friends), educational (e.g., degree(s), university attended, other training), etc. A member's profile, or attributes or dimensions of a member's profile, may be used in various ways by system components (e.g., to identify who sent a message, to identify a recipient of a status update, to select content to serve to the member or an associated member, to record a content-delivery event, to provide insight regarding the member's connections). Some or all profile data of a member may be retained permanently or for a long period of time.

Organizations may also be members of the service(s) (i.e., in addition to individuals), and may have associated descriptions or profiles comprising attributes such as industry (e.g., information technology, manufacturing, finance), size, location, goal, etc. An organization may be a company, a corporation, a partnership, a firm, a government agency or entity, a not-for-profit entity, a group or collection of associated members, or some other entity formed for virtually any purpose (e.g., professional, social, educational). Either or both organizations and individual members may “follow” and/or be followed by other members.

A content server may maintain one or more repositories of content items for serving to members (e.g., within data storage system 130 and/or elsewhere), an index of the content items, and/or other information useful in serving content to members. Illustratively, content server 114 may serve on the order of hundreds of millions of items or objects every day. A content store may include various types of sponsored and/or unsponsored content items for serving to members and/or for use by various components of system 110, which may be generated within the system or by external entities. A content server (or some other component of system 110) may include a recommendation module for recommending specific content to serve to a member.

A tracking server may monitor and record (e.g., within data storage system 130 and/or elsewhere) activity of system 110 and/or members. For example, whenever content is served from the system (e.g., to a client device), the tracking server may be informed of what is served, to whom (e.g., which member), when it was served, and/or other information. Similarly, the tracking server may also receive notifications of member actions regarding content actions, to include identities of the member and the content acted upon, the action that was taken, when the action was taken, etc. Illustrative actions that may be captured include, but are not limited to, clicks/taps/pinches (on the content, on a logo or image), conversions, follow-on requests, visiting a page associated with a subject or provider of the content, taking some other action regarding the content (e.g., commenting on it, sharing it, following its provider, liking it), and so on.

Members of a service hosted by system 110 have corresponding pages (e.g., web pages, content pages) on the system, which they may use to facilitate their activities with the system and with each other, to form connections/relationships with other members, to view their connections and/or information regarding their connections, to review their profiles, to inform friends and/or colleagues of developments in their lives/careers, etc. These pages (or information provided to members via these pages) are available to some or all other members. Members' pages may be stored within data storage system 130 or elsewhere.

System 110 may include yet other components, services, and/or servers not illustrated in FIG. 1. Also, functionality attributed herein to system 110 may be distributed among its components in an alternative manner, such as by merging or further dividing functions of one or more components, or may be distributed among a different collection of components. Yet further, while depicted as separate and individual hardware components (e.g., computer servers) in FIG. 1, one or more of portal 112, delivery server 114, and services 120 may alternatively be implemented as separate software modules executing on one or more computer servers. Thus, although only a single instance of a particular component of system 110 may be illustrated in FIG. 1, it should be understood that multiple instances of some or all components may be utilized.

In some embodiments, content requests are initially received at portal 112, before being passed to services 120 and/or other components of system 110 for processing. For example, a browser program or other application executing on a member's device may transmit a request for a home page, a personal page, a profile page, or some other page (or collection) of content offered by the system. In response, portal 112 or another component identifies individual objects or components of the requested content, with URLs (Uniform Resource Locators), addresses, and/or other identifiers.

Portal 112 (e.g., a web server operating on the portal) rewrites the identifiers in order to associate individual objects or components with available content delivery networks (CDNs) according to the methods described herein (e.g., in order of the objects' importance). Rewritten URLs are included in the portal's response to the content request, and the operative client device retrieves the objects via their assigned CDNs.

Delivery server 114 assists in the allocation or assignment of individual content objects/components to different content delivery networks by ranking objects in terms of importance (and/or other factors) and by ranking networks in terms of price, performance, and/or other factors. These rankings and/or other information regarding content and/or delivery networks are stored at delivery server 114 or in storage that is accessible to the delivery server (e.g. storage system 130)

Objects or components of some content pages (or other content compilations or collections that may be served by system 110), such as static pages, may be ranked relatively infrequently (e.g., once, after every update). Objects of other pages, such as dynamic pages, may be ranked more frequently, possibly every time such a page is to be served in response to a request that can be satisfied by using multiple CDNs. CDNs may be ranked on an infrequent basis, or even just once, unless a network configuration (e.g., number of servers, server locations) or price structure changes in a substantive manner.

Therefore, delivery server 114 may rank components of a content page or collection as part of the process of serving the page/collection, or may retrieve from storage a previously configured ranking of those components and a ranking of the CDNs. A portal, web server, or other system component that rewrites object URLs may thus refer to delivery server 114 when allocating or assigning objects to CDNs, or may retain some or all necessary information (e.g., rankings) in memory for repeated use.

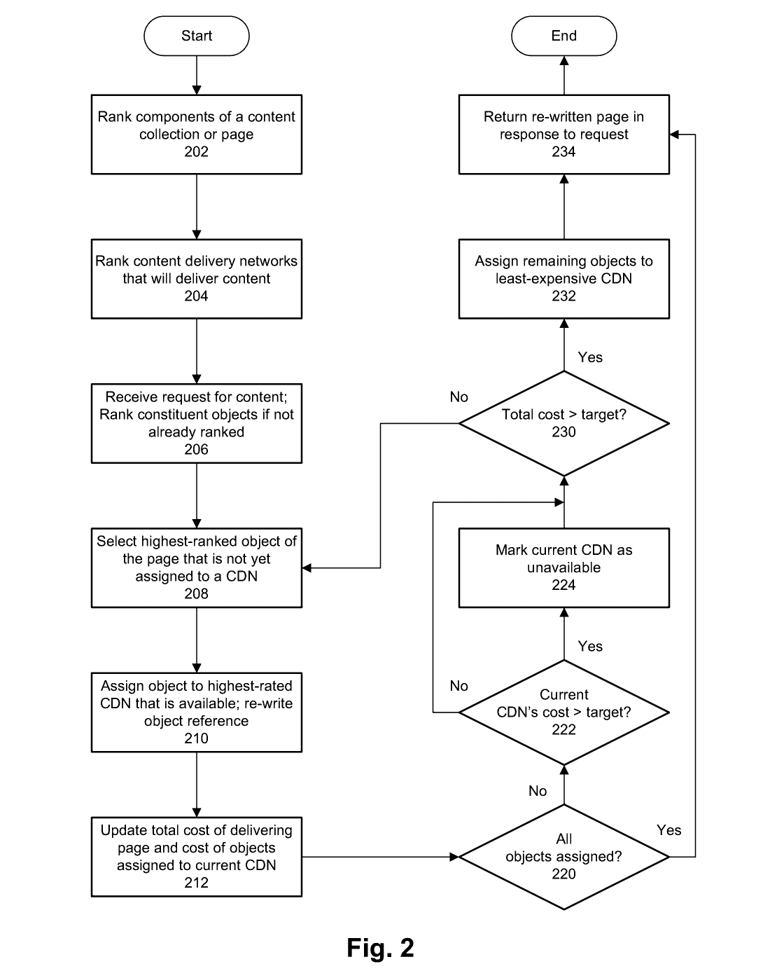

FIG. 2 is a flow chart illustrating a method of assigning or allocating content objects from a page or other collection of content, to content delivery networks, according to some embodiments. In one or more embodiments, one or more of the illustrated operations may be omitted, repeated, and/or performed in a different order. Accordingly, the specific arrangement of steps shown in FIG. 2 should not be construed as limiting the scope of the embodiments.

Although the method of FIG. 2 is discussed as it may be applied to handle requests for content pages having multiple constituent objects, the method may be readily modified to handle requests for other content collections, such as a set of multiple pages.

In operation 202, one or more pages of content (or other content compilations or collections) offered by a content provider, such as a professional or social network for example, are profiled. In the illustrated embodiment, profiling a page entails ranking its constituent objects based on some measure or reflection of their importance. The pages may include static and/or dynamic pages.

In some implementations, the process of profiling a content page yields a table or matrix of rankings. In this data structure, some or all of the constituent objects are represented by separate entries that identify the object, indicate its rank, identify its size, and/or that include other information. Some objects may not be ranked if, as described below, a specific rule defines how to assign them to appropriate content delivery networks.

To rank the objects of a given page, in different implementations different factors may have different weights and therefore result in different rankings. For example, in one illustrative implementation, an object's type (e.g., file type) may be the most significant factor in determining its rank. In this implementation, those types of objects that have greater impact on rendering, assembling, or constructing the page, or that have greater impact on a user's experience with or enjoyment of the page, have higher ranks. Thus, in this implementation, a cascading style sheet (a .css file), a file containing markup language (e.g., an .html or .xml file), and scripts (e.g., a .js file) generally will be considered more important than images (e.g., .jpg files) and videos (e.g., .mpeg files).

In another illustrative implementation, within a page that will (or is likely to) require a user to scroll in order to see the entire page (e.g., a page of content to be presented on a mobile device having a relatively small display screen), objects that will appear first when the page is displayed (i.e., before the user scrolls the display) are considered more important than objects that only become visible after the view is scrolled. Thus, the objects' presentation or rendering locations may have great significance.

In other implementations, other factors are more significant and/or multiple factors influence an object's importance ranking. Thus, factors such as type and presentation location may significantly affect an object's ranking, as described above, and/or other factors may be considered, such as the object's size, a business purpose associated with the object (e.g., sponsored content, unsponsored content, part of a public service), the object's prominence among a group of objects of the same type (e.g., the first of several images may be more important than the last), and so on.

In operation 204, each of multiple CDNs (Content Delivery Networks) that the content provider uses to deliver content to users is profiled. The profiling results in a ranking of the networks, based on their throughput or some other measure of performance.

In some embodiments, the result is stored as a table or matrix that identifies each network, reflects each network's ordinal ranking as an integer value between 1 and N, wherein N is the number of networks that have been profiled. The rankings may include other information. For example, each network's entry in the table or matrix may identify a cost of using that network, which may be expressed as a cost per object, a cost per data amount (e.g., KB, MB, GB), or in some other manner.

In other embodiments, yet other information may be included with the CDNs' rankings. Also, instead of ordinal rankings of the networks based on their performance, some other indication of their relative performances may be used, such as a raw performance measurement, an average delivery time (per object, per quantity of data), and so on.

It may be noted that, whereas a content page may be profiled multiple times (e.g., every time it is reconfigured), especially a dynamic page, the content providers' CDNs may only need to be profiled once. For example, a CDN may be re-profiled only if its configuration (e.g., number of servers, server locations) changes in a significant way.

In operation 206, a request is received for a page of content, at a web server or portal operated by or for the content provider. A template, script, markup file, or other document that identifies constituent objects of the page is retrieved. The requested page may or may not have been profiled in operation 202.

For example, in some embodiments, the request may be for a dynamic page, and dynamic pages may not have been ranked in operation 202. In these embodiments, these types of objects are ranked after the request is received, and may be ranked in a manner described above.

If the components of the requested content were ranked previously, and do not need to be re-ranked, those rankings are retrieved from memory, from local storage, from another system component, or elsewhere. Similarly, when a page is profiled only upon receipt of a request for the page, the resulting rankings may be recorded.

Also in operation 206, a “target total cost” associated with the requested page and “target CDN costs” associated with each CDN that can or will be used to deliver individual components are retrieved, calculated, or estimated. In the illustrated method, the target total cost is an average cost, median cost, or some other amount representative of a cost of serving/delivering the requested page. Illustratively, it may represent historical costs of serving just the requested page, of serving any/all pages offered by the content provider, of serving similar pages, or some other collection of pages. In short, the target total cost represents an acceptable cost of serving the requested page—a cost that may be exceeded, however.

By way of illustration, performance or user enjoyment of delivery of the requested page could be enhanced by sending the entire page via the fastest or best content delivery network, but the cost of doing so for every page or even just every time this page is requested, would likely be exorbitant. The target total cost therefore provides a target for the actual cost of sending the page, which will hopefully be less, but which may be more.

A “target CDN cost” is similar to the target total cost, but represents a target cost of using a particular CDN. A given CDN's target cost may be calculated as a percentage of the target total cost if, for example, the content provider strives to apportion its traffic (e.g., the delivery of requested content via content delivery networks) among multiple CDNs in a particular manner or with some particular ratio or weighting. Apportionments among the CDNs may or may not be equal. For example, if three CDNs are employed, the content provider may attempt to use one CDN for 40% of its traffic (as measured by cost) and use each of the other two for 30%.

In some embodiments, a “target CDN delivery percentage” is applied instead of, or in addition to, a target CDN cost. In these embodiments, the amount of content (e.g., number of objects, quantity of data) allocated to a given CDN from the content page is limited to its corresponding target CDN delivery percentage.

In operation 208, the highest-ranked object of the page, among the objects that have not yet been assigned or allocated to a CDN for delivery in response to the request, is selected for assignment/allocation.

In operation 210, the selected object is assigned to the highest-ranked CDN that is still available. It may be noted that all CDNs that the content provider uses (or could use) for delivering the requested content to the requesting member/user may initially be considered “available” for responding to the current request, at the time the request was received and the assignment of objects to CDNs commenced.

The operation of assigning an object to a CDN also entails rewriting the URL or other object identifier so that when it is retrieved/served, it is delivered via the assigned CDN. For example, if the requested page is an HTML page, each URL that will be transmitted to the requester's browser as part of the page, so that it can retrieve the corresponding object, is modified so that the object is retrieved or delivered via the allocated CDN.

In operation 212, based on a cost of delivering or sending the selected object via the current CDN (i.e., the CDN to which the selected object has been assigned), the total cost of sending the page's object is updated and a total cost associated with the current CDN (e.g., a “CDN cost”) is also updated. These costs will accumulate during the illustrated process, and will be compared with the “target total cost” and “target CDN costs” discussed above. In addition, a measure of the amount of content (e.g., number of objects, quantity of data, percentage of the content page) assigned to the current CDN may also be updated.

The cost of sending a given object may be a per-object cost, in which case each object assigned to the same CDN will incur the same cost, may be a per-size cost, in which case each object's cost will depend on its size, or the cost may be determined in some other manner. For example, a tiered scale may be applied in which objects within different ranges of sizes incur different costs.

In operation 220, it is determined whether all objects of the requested page have now been assigned or allocated to CDNs for delivery to the content requester. If so, the method advances to operation 234; otherwise, the method continues at operation 222.

In operation 222, the total CDN cost for the current CDN is compared to its target CDN cost, and/or the amount of content assigned to the current CDN is compared to a target amount or percentage. If the total CDN cost is greater than (or possibly equal to) the target and/or the total amount of assigned content is greater than (or possibly equal to) the target, the method proceeds to operation 224; otherwise, the method advances to operation 230.

In operation 224, because the current CDN has been allocated its share of content of the requested page, in terms of cost, that CDN is now marked “unavailable,” meaning that it will not receive any further object allocations via operation 208. In some other embodiments, a given CDN's share of a set of requested content may be measured by number of objects or amount of data, in which case these values may be tracked instead of cost.

In operation 230, the current total accumulated cost of delivering the page is compared to its target total cost. If the total accumulated cost exceeds (or possibly is equal to) the target total cost, the method continues to operation 232; otherwise, the method returns to operation 208 to assign the next most important object to an available CDN.

In operation 232, because the total cost of delivering the page has already exceeded its target, any remaining objects, which have not yet been assigned to CDNs, are allocated to the least-expensive CDN, or possibly the least-expensive CDN that is still “available.” Because the most important objects have already been assigned (to the best/better performing CDNs), sending the least important, least significant, and/or least impactful objects via what may be the worst-performing CDN may not have any (or much) impact on the requester's use of or enjoyment of the page.

In other embodiments, other schemes may be applied to allocate the remaining objects. For example, they may be randomly assigned among all CDNs (or just among “available” CDNs), among the X least-expensive CDNs (X>1), etc.

In operation 234, the rewritten page—in other words, the requested page as it has been modified to ensure that its objects are delivered via their assigned CDNs—is returned in response to the request.

Thus, sometime after operation 234, the requester (e.g., a device operated by a user) will use the page to request the individual objects and will receive them via the appropriate CDNs.

After operation 234, the method ends.

In some embodiments, rules may be applied that cause some objects or types of objects to be assigned to certain CDNs, which may not be the best ones available when those objects would otherwise be assigned to CDNs. For example, key objects (e.g., .css files, .js files, .html files) may be sent via the best-performing (i.e., highest ranked) content delivery network. Similarly, a relatively large object may automatically be assigned to the cheapest network. Rules for assigning objects may be applied before the normal allocation of objects (e.g., prior to operation 208 of the method of FIG. 2).

Similarly, some entire pages may be allocated to specific content delivery networks, possibly obviating any need to profile them and rank their objects. For example, a home page or other page that is important to a user's experience at a web site may be assigned to the best-performing CDN, especially if the page is relatively small (e.g., contains few objects).

In some embodiments, when allocation of objects among content delivery networks is aborted (e.g., because the total cost exceeded a target total cost), the allocation process may be restarted instead of simply allocating the remaining objects in some manner. For example, when a static page of content that does not change very often is profiled, the allocation process may be repeated one or more times (and/or the page's objects may be ranked in different orders) until a lowest total cost is encountered. This repetition of the allocation process may occur in advance of receipt of any request for the static page.

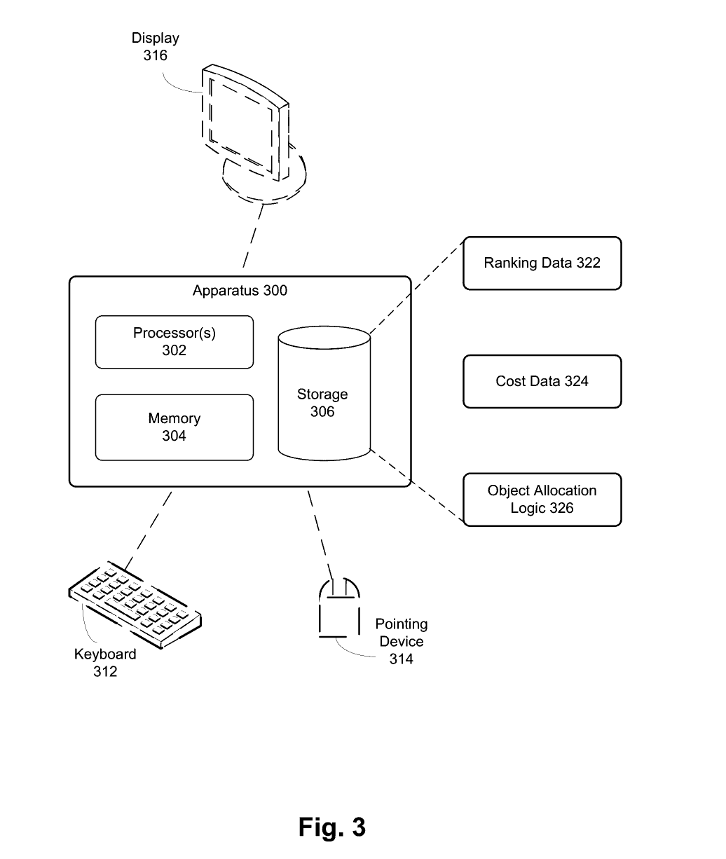

FIG. 3 is a block diagram of an apparatus for assigning content objects to different content delivery networks, based on the objects' importance, according to some embodiments.

Apparatus 300 of FIG. 3 includes processor(s) 302, memory 304, and storage 306, which may comprise one or more optical, solid-state, and/or magnetic storage components. Storage 306 may be local to or remote from the apparatus. Apparatus 300 can be coupled (permanently or temporarily) to keyboard 312, pointing device 314, and display 316.

Storage 306 stores data used by the apparatus to support the allocation of content to different content delivery networks. Such data may include ranking data 322, cost data 324, and/or other information.

Ranking data 322 includes rankings of components of one or more content pages (or other types of content collections) according to their subjective or objective importance—such as how important they are to presentation or use of the content page. Ranking data 322 also includes rankings of two or more content delivery networks based on their performance (e.g., throughput, delivery time). Ranking data 322 may include other associated information, such as sizes of ranked objects, their addresses (e.g., URLs), costs of sending a given object or a given set of data via different CDNs, etc.

Cost data 324 includes target total costs of sending different content pages, and information for determining how much data from a page (or how many of the page's objects) to send through each network. This information may comprise percentages of traffic (or percentages of total costs) apportioned to the different networks, a maximum number of objects (of specific pages, of any page) or a maximum amount of data (of specific pages, of any page) to deliver via the network, and/or other information.

In addition to ranking data 322 and cost data 324, storage 306 also stores logic that may be loaded into memory 304 for execution by processor(s) 302. Such logic includes object allocation logic 326. In other embodiments, this logic module may be divided to separate its functionality as desired.

Object allocation logic 326 comprises processor-executable instructions for assigning content pages and/or objects of a given content page to the different content delivery networks, for delivery to a requesting user. These assignments, or allocations, may be performed in order of the importance of the content, and/or may be based on rules for mapping content to networks (the rules may also be stored in storage 306).

During allocation of content to networks, logic 326 will attempt to enforce any specified apportionment of traffic among the different content delivery networks, such as enforcing a target CDN cost and making a CDN “unavailable” for additional objects of a given content page after that target CDN cost has been incurred for the page. Logic 326 will also terminate the object allocation process (and/or restart it with at least one different target cost or other parameter) if a target total cost of the page is exceeded, which may result in all unallocated objects being assigned in some default manner (e.g., to the least expensive CDN).

Storage 306 may also include logic for profiling content for profiling content delivery networks.

In some embodiments, apparatus 300 performs some or all of the functions ascribed to one or more components of system 110 of FIG. 1.

From the preceding discussion it may be seen that, in some embodiments, allocating multiple objects of a content page for delivery to a user or device via multiple content delivery networks (CDNs) involves: (1) receiving a request for delivery to a user of the content page; (2) obtaining (or creating) a ranking of the multiple objects; (3) obtaining (or creating) a ranking of the CDNs available for delivery of content objects to the user; (4) selecting, among the multiple objects, the highest-ranked object that has not yet been assigned to one of the multiple CDNs, for delivery to the user; (5) assigning the selected object to the highest-rank CDN, among the multiple CDNs, that is available; (6) based on a cost of delivering the selected object via the assigned CDN, updating (i) a total cost of delivering the page and (ii) a cost of delivering objects from the page via the assigned CDN; (7) repeating said (3) through said (6) until one or more of: (i) each of the multiple objects has been assigned to a CDN and (ii) the total cost exceeds a threshold total cost; wherein a given CDN becomes unavailable when the cost of delivering objects from the page via the given CDN exceeds a threshold CDN cost.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

1. A method, comprising:
receiving a request for an electronic page of multiple objects to be delivered to a user via multiple available content delivery networks (CDNs);
based on a ranking of the multiple objects and a ranking of the multiple CDNs, assigning each object, in order of its rank, to a highest-ranking available CDN for delivery to the user, until one or more of:
a first accumulated cost of delivering the assigned objects to the user exceeds a threshold total cost;
each of the multiple objects has been assigned to a CDN; and
no CDN is available;
wherein a given CDN becomes unavailable when a second accumulated cost of delivering objects of the page assigned to the given CDN exceeds a threshold CDN cost associated with the given CDN;
wherein the highest-ranking available CDN has the best performance, wherein a performance of a CDN indicates how fast a given object can be delivered via the CDN; and
upon determining that the first accumulated cost exceeds the threshold total cost, assigning unassigned objects to a least-expensive CDN that is still available.

2. The method of claim 1, further comprising:
configuring the page to identify, for each object, the CDN to which the object has been assigned; and
returning the configured page in response to the request.

3. The method of claim 1, wherein said assigning an object comprises:
determining a cost of delivering the assigned object to the user via the assigned CDN;
adding the cost to the first accumulated cost; and
adding the cost to the second accumulated cost associated with the assigned CDN.

4. The method of claim 1, further comprising, when the first accumulated cost of delivering the assigned objects to the user exceeds a threshold total cost:
identifying one or more unassigned objects among the multiple objects, wherein the unassigned objects have not been assigned to a CDN for delivery to the user; and
assigning each of the unassigned objects to the CDN, among the multiple CDNs, that has a lowest associated cost of delivery objects to the user.

5. The method of claim 1, further comprising, when the first accumulated cost of delivering the assigned objects to the user exceeds a threshold total cost:
identifying one or more unassigned objects among the multiple objects, wherein the unassigned objects have not been assigned to a CDN for delivery to the user; and
for each of the unassigned objects, randomly assigning the unassigned objects to one of the multiple CDNs.

6. The method of claim 5, wherein the unassigned objects are only assigned to CDNs that are available at the time of said identifying.

7. The method of claim 1, further comprising:
ranking the multiple objects by importance, based on one or more of:
file type;
size; and
a location in which the objects will be displayed on a display
screen of a device operated by the user; and
ranking the multiple CDNs by performance.

8. An apparatus, comprising:
one or more processors; and
memory storing instructions that, when executed by the one or more processors, cause the apparatus to:
receive a request for an electronic page of multiple objects to be delivered to a user via multiple available content delivery networks (CDNs);
based on a ranking of the multiple objects and a ranking of the multiple CDNs, assign each object, in order of its rank, to a highest-ranking available CDN for delivery to the user, until one or more of:
a first accumulated cost of delivering the assigned objects to the user exceeds a threshold total cost;
each of the multiple objects has been assigned to a CDN; and
no CDN is available;
wherein a given CDN becomes unavailable when a second accumulated cost of delivering objects of the page assigned to the given CDN exceeds a threshold CDN cost associated with the given CDN;
wherein the highest-ranking available CDN has the best performance, wherein a performance of a CDN indicates how fast a given object can be delivered via the CDN; and
upon determining that the first accumulated cost exceeds the threshold total cost, assign unassigned objects to a least-expensive CDN that is still available.

9. The method of claim 8, wherein the memory further stores instructions that, when executed by the one or more processors, cause the apparatus to:
configure the page to identify, for each object, the CDN to which the object has been assigned; and
return the configured page in response to the request.

10. The apparatus of claim 8, wherein said assigning an object comprises:
determining a cost of delivering the assigned object to the user via the assigned CDN;
adding the cost to the first accumulated cost; and
adding the cost to the second accumulated cost associated with the assigned CDN.

11. The apparatus of claim 8, wherein the memory further stores instructions that, when executed by the one or more processors, cause the apparatus to, when the first accumulated cost of delivering the assigned objects to the user exceeds a threshold total cost:
identify one or more unassigned objects among the multiple objects, wherein the unassigned objects have not been assigned to a CDN for delivery to the user; and
assign each of the unassigned objects to the CDN, among the multiple CDNs, that has a lowest associated cost of delivery objects to the user.

12. The apparatus of claim 8, wherein the memory further stores instructions that, when executed by the one or more processors, cause the apparatus to, when the first accumulated cost of delivering the assigned objects to the user exceeds a threshold total cost:
identify one or more unassigned objects among the multiple objects, wherein the unassigned objects have not been assigned to a CDN for delivery to the user; and
for each of the unassigned objects, randomly assign the unassigned objects to one of the multiple CDNs.

13. The apparatus of claim 12, wherein the unassigned objects are only assigned to CDNs that are available at the time of said identifying.

14. The apparatus of claim 8, wherein the memory further stores instructions that, when executed by the one or more processors, cause the apparatus to:
rank the multiple objects by importance, based on one or more of:
file type;
size; and
a location in which the objects will be displayed on a display screen of a device operated by the user; and
rank the multiple CDNs by performance.

15. A system, comprising:
one or more processors; and
a content allocation module comprising a non-transitory computer-readable medium storing instructions that, when executed, cause the system to:
receive a request for an electronic page of multiple objects to be delivered to a user via multiple available content delivery networks (CDNs);
based on a ranking of the multiple objects and a ranking of the multiple CDNs, assign each object, in order of its rank, to a highest-ranking available CDN for delivery to the user, until one or more of:
a first accumulated cost of delivering the assigned objects to the user exceeds a threshold total cost;
each of the multiple objects has been assigned to a CDN; and
no CDN is available;
wherein a given CDN becomes unavailable when a second accumulated cost of delivering objects of the page assigned to the given CDN exceeds a threshold CDN cost associated with the given CDN;
wherein the highest-ranking available CDN has the best performance, wherein a performance of a CDN indicates how fast a given object can be delivered via the CDN; and
upon determining that the first accumulated cost exceeds the threshold total cost, assign unassigned objects to a least-expensive CDN that is still available.

16. The system of claim 15, wherein said assigning an object comprises:
determining a cost of delivering the assigned object to the user via the assigned CDN;
adding the cost to the first accumulated cost; and
adding the cost to the second accumulated cost associated with the assigned CDN.

17. The system of claim 15, wherein the non-transitory computer-readable medium of the content allocation module further stores instructions that, when executed by the one or more processors, cause the system to:
when the first accumulated cost of delivering the assigned objects to the user exceeds a threshold total cost:
identify one or more unassigned objects among the multiple objects, wherein the unassigned objects have not been assigned to a CDN for delivery to the user; and
assign each of the unassigned objects to the CDN, among the multiple CDNs, that has a lowest associated cost of delivery objects to the user.

18. The system of claim 15, wherein the non-transitory computer-readable medium of the content allocation module further stores instructions that, when executed by the one or more processors, cause the apparatus to:
when the first accumulated cost of delivering the assigned objects to the user exceeds a threshold total cost:
identify one or more unassigned objects among the multiple objects, wherein the unassigned objects have not been assigned to a CDN for delivery to the user; and
for each of the unassigned objects, randomly assign the unassigned objects to one of the multiple CDNs.

19. The system of claim 18, wherein the unassigned objects are only assigned to CDNs that are available at the time of said identifying.

20. The system of claim 15, further comprising:
a ranking module comprising a non-transitory computer-readable medium storing instructions that, when executed, cause the system to:
rank the multiple objects by importance, based on one or more of:
file type;
size; and
a location in which the objects will be displayed on a display screen of a device operated by the user; and
rank the multiple CDNs by performance.
